(19) United States
(12) Patent Application Publication
(10) Pub. No.: US 2004/0191133 A1
(43) Pub. Date: Sep. 30, 2004

(54) Catalyst-carried filter, exhaust gas purification system using the same, and catalyst body

(75) Inventor: Shinji Yamaguchi, Ama-gun (JP)

Correspondence Address: OLIFF & BERRIDGE, PLC, P.O. BOX 19928, ALEXANDRIA, VA, 22320, US

(73) Assignee: NGK INSULATORS, LTD., Nagoya-city (JP)

(21) Appl. No.: 10/784,303

(22) Filed: Feb. 24, 2004

(30) Foreign Application Priority Data
Mar. 28, 2003 (JP) 2003-092066

(51) Int. Cl. B01D 53/34

(52) U.S. Cl. 422/180; 422/177; 422/171

(57) ABSTRACT

A catalyst-carried filter includes a honeycomb structure including a plurality of cells partitioned by partition walls, and an oxidation catalyst for promoting oxidation of the particulates contained in an exhaust gas. An exhaust gas inflow cell whose one opening end is clogged and in which the oxidation catalyst is carried on the surface of the partition wall, and a purified gas outflow cell whose other opening end is clogged are alternately arranged, and at least one fine coating layer constituted of a porous ceramic having an average pore diameter smaller than that of the porous ceramic constituting the partition wall is formed on a surface of the partition wall on a purified gas outflow cell side. The catalyst-carried filter capable of securely trapping/collecting particulates contained in an exhaust gas, and also sufficiently bringing an oxidation catalyst into contact with the particulates, so that it is possible to reduce the particulates in the exhaust gas and to lower a frequency of reproducing operation of the filter.

### BACKGROUND OF THE INVENTION

1. Field of the Invention

The present invention relates to a catalyst-carried filter, an exhaust gas purifying system, and a catalyst body for use in trapping/collecting or purifying particulates contained in an exhaust gas exhausted from internal combustion engines such as a diesel engine or various combustion devices.

2. Description of Related Art

An exhaust gas exhausted from internal combustion engines such as a diesel engine or various combustion devices (hereinafter referred to as “the internal combustion engine or the like”) contains a large amount of particulates (particulate materials) mainly formed of soot (black smoke). When the particulates are discharged to the atmosphere as they are, pollution is caused. Therefore, it is general to mount a filter for trapping/collecting the particulates in an exhaust gas channel from the internal combustion engine or the like.

Examples of the filter for use in this purpose include a honeycomb filter shown in FIG. 2, including a honeycomb structure 21 including a plurality of cells 23 partitioned by partition walls 24 formed of a porous ceramic including a large number of pores to constitute the channel of the gas. In the honeycomb filter, one opening end and the other opening end of the plurality of cells 23 are alternately,clogged by clogging portions 22. When an exhaust gas G₁ flows into the honeycomb filter via an exhaust gas inflow cell, the particulates in the exhaust gas G₁ are trapped/collected by the partition walls during passage of the exhaust gas G₁ through the partition wall 24, and a purified gas G₂ from which the particulates have been removed flows out of a purified gas outflow cell.

Moreover, in recent years, a honeycomb filter (hereinafter referred to as “the catalyst-carried filter”) including an oxidation catalyst for promoting oxidation (combustion) of the particulates has been used. In this catalyst-carried filter the oxidation catalyst is usually carried on the surfaces of the partition walls of the honeycomb filter and inner surfaces of pores existing in the partition walls. In the catalyst-carried filter, the particulates in the exhaust gas are trapped/collected by the partition walls. Additionally, the oxidation (combustion) of the particulates is promoted. Accordingly, the particulates in the exhaust gas can be reduced, and it is possible to effectively purify the exhaust gas.

Additionally, in the catalyst-carried filter constituted of a porous ceramic having an average pore diameter to such an extent that the particulates contained in the exhaust gas can securely be trapped/collected, most of the particulates contained in the exhaust gas are deposited on the surface of the partition wall of the filter on an exhaust gas inflow cell side, and do not enter the pores existing in the partition walls. That is, the oxidation catalyst carried on the inner surfaces of the pores existing in the partition walls does not contact any particulate, and is not effectively used. Since the oxidation (combustion) of the particulates cannot sufficiently be promoted and the particulates in the exhaust gas cannot be reduced in this state, the particulates are deposited on the surfaces of the partition walls on the exhaust gas inflow cell side in a comparatively short period. There is a problem that a reproducing operation of the filter (operation of removing the deposited particulates by reverse washing or heating) has to be frequently carried out.

To solve the problem, as the catalyst carrying honeycomb filter having a basic constitution similar to the above-described constitution, there has been proposed an exhaust gas purifying device characterized in that an average opening diameter of the pore existing in the partition wall on the exhaust gas inflow cell side is larger than that on a purified gas outflow cell side (e.g., see Japanese Patent Application Laid-Open No. 2002-309921).

Since the average opening diameter of the pore existing in the partition wall on the exhaust gas inflow cell side is large in this exhaust gas purifying device, the particulates contained in the exhaust gas can easily enter not only the surface of the partition wall on the exhaust gas inflow cell side but also the pores existing in the partition wall. On the other hand, since the average opening diameter of the pore of the partition wall on the purified gas outflow cell side is small, the particulates do not leak on the purified gas outflow cell side. Therefore, the particulates contained in the exhaust gas can efficiently be trapped/collected. Additionally, a contact degree of the particulates with the oxidation catalyst carried in the pores existing in the partition wall is enhanced, and it is considered that the oxidation (combustion) of the particulates can sufficiently be promoted.

Additionally, in consideration of Japanese Patent Application Laid-Open No. 2002-309921 described above, it is assumed that the pore existing in the partition wall exists as a barrel type space whose pore diameter is gradually reduced toward the opposite surfaces of the partition wall from a middle of the partition wall in a thickness direction in the above-described exhaust gas purifying device. It is also described that one surface of the partition wall is removed by a surface modifier and hence the average opening diameter of the pore in the partition wall facing the exhaust gas inflow cell is constituted to be greater than that of the pore in the partition wall facing the purified gas outflow cell. That is, the opening diameter of one pore is changed, that of one opening is enlarged, and that of the other opening is reduced.

However, for example, as shown in FIG. 3, pores 25 in a partition wall 24 formed of a porous ceramic are formed by voids among aggregate particles bonded to one another by sintering, and therefore it is supposed that the pores do not exist as the above-described barrel type spaces. Accordingly, it has been actually difficult to use the constitution of the exhaust gas purifying device described in Japanese Patent Application Laid-Open No. 2002-309921. That is, even if an oxidation catalyst 26 is carried in the pores 25 in the partition wall 24 as shown in FIG. 3, it has been impossible to obtain an effect of the exhaust gas purifying device described in Japanese Patent Application Laid-Open No. 2002-309921.

The present invention has been developed in consideration of the above-described related-art problems, and an object thereof is to provide a catalyst-carried filter which is, needless to say, capable of securely trapping/collecting particulates contained in an exhaust gas and which allows an oxidation catalyst carried in pores existing in a partition wall to sufficiently contact the particulates, so that it is possible to reduce the particulates in the exhaust gas and to reduce a frequency of reproducing operation of a filter.

### SUMMARY OF THE INVENTION

As a result of intensive researches for solving the above-described problems, the present inventors have realized that at least one fine coating layer constituted of a porous ceramic having an average pore diameter smaller than that of a porous ceramic constituting a partition wall is formed on the surface of the partition wall for partitioning a plurality of cells in a catalyst-carried filter constituted as described above and that the problem can accordingly be solved, and have completed the present invention.

According to the present invention, there is provided a catalyst-carried filter comprising: a honeycomb structure including a plurality of cells which are partitioned by partition walls constituted of a porous ceramic including a large number of pores to constitute a channel of a gas; and an oxidation catalyst which is carried on the surfaces of the partition walls and inner walls of the pores existing in the partition walls to promote oxidation of particulates contained in an exhaust gas, the plurality of cells including one opening end and the other opening end which are alternately clogged, wherein the plurality of cells include exhaust gas inflow cells whose one opening end is clogged and in which the oxidation catalyst is carried on the surfaces of the partition walls, and purified gas outflow cells whose other opening end is clogged, the exhaust gas inflow cells and the purified gas outflow cells are alternately arranged, and at least one fine coating layer constituted of a porous ceramic having an average pore diameter smaller than that of the porous ceramic constituting the partition wall is formed on the surface of the partition wall on the side of the purified gas outflow cell.

In the catalyst-carried filter, the average pore diameter of the porous ceramic constituting the partition wall is preferably 15 to 300 μm, and the average pore diameter of the porous ceramic constituting the fine coating layer is preferably 5 to 50 μm.

In the catalyst-carried filter, it is preferable that the porous ceramic constituting the partition wall has a porosity of 40 to 75%, and that the porous ceramic constituting the fine coating layer has a porosity of 45 to 85%.

In catalyst-carried filter, it is preferable that the porosity of the porous ceramic constituting the partition wall is smaller than that of the porous ceramic constituting the fine coating layer by 5% or more.

According to the present invention, there is also provided a catalyst-carried filter comprising: a honeycomb structure including a plurality of cells which are partitioned by partition walls constituted of a porous ceramic including a large number of pores to constitute a channel of a gas; and an oxidation catalyst which is carried on the surfaces of the partition walls and inner walls of the pores existing in the partition walls to promote Oxidation of particulates contained in an exhaust gas, the plurality of cells including one opening end and the,other opening end which are alternately clogged, wherein the plurality of cells include exhaust gas inflow cells whose one opening end is clogged and in which the oxidation catalyst is carried on the surfaces of the partition walls, and purified gas outflow cells whose other opening end is clogged, the exhaust gas inflow cells and the purified gas outflow cells are alternately arranged, and at least one particulate layer filled with a porous ceramic having an average pore diameter smaller than that of the porous ceramic constituting the partition wall is formed on the side of the purified gas outflow cell inside the pore existing in the partition wall.

In the catalyst-carried filter, the average pore diameter of the porous ceramic constituting the partition wall is preferably 15 to 300 μm, and the average pore diameter of the porous ceramic constituting the particulate layer is preferably 5 to 50 μm.

In the catalyst-carried filter, it is preferable that the porous ceramic constituting the partition wall has a porosity of 40 to 75%, and that the porous ceramic constituting the particulate layer has a porosity of 45 to 85%.

In the catalyst-carried filter, it is preferable that the porosity of the porous ceramic constituting the partition wall is smaller than that of the porous ceramic constituting the particulate layer by 5% or more.

According to the present invention, there is further provided a catalyst-carried filter comprising: a honeycomb structure including a plurality of cells which are partitioned by partition walls constituted of a porous ceramic including a large number of pores to constitute a channel of a gas; and an oxidation catalyst which is carried on the surfaces of the partition walls and inner walls of the pores existing in the partition walls to promote oxidation of particulates contained in an exhaust gas, the plurality of cells including one opening end and the other opening end which are alternately clogged, wherein the plurality of cells include exhaust gas inflow cells whose one-opening end is clogged and in which the oxidation catalyst is carried on the surfaces of the partition walls, and purified gas outflow cells whose other opening end is clogged, the exhaust gas inflow cells and the purified gas outflow cells are alternately arranged, at least one coarse coating layer constituted of a porous ceramic having an average pore diameter larger than that of the porous ceramic constituting the partition wall is formed on the surface of the partition wall on the side of the exhaust gas inflow cell, and the oxidation catalyst is carried on the surface of the coarse coating layer and the inner walls of the pores existing in the coarse coating layer.

In the catalyst-carried filter, the average pore diameter of the porous ceramic constituting the partition wall is preferably 5 to 50 μm, and the average pore diameter of the porous ceramic constituting the coarse coating layer is preferably 15 to 300 μm.

In the catalyst-carried filter, it is preferable that the porous ceramic constituting the partition wall has a porosity of 45 to 80%, and that the porous ceramic constituting the coarse coating layer has a porosity of 40 to 75%.

In the catalyst-carried filter, it is preferable that the porosity of the porous ceramic constituting the partition wall is larger than that of the porous ceramic constituting the coarse coating layer by 5% or more.

In the catalyst-carried filter, it is preferable that at least one fine coating layer which is constituted of a porous ceramic having an average pore diameter smaller than that of the porous ceramic constituting the partition wall, is formed on the surface of the partition wall on the purified gas outflow cell side.

In the catalyst-carried filter, it is preferable that at least one particulate layer which is filled with the porous ceramic having an average pore diameter smaller than that of the porous ceramic constituting the partition wall, is formed on the purified gas outflow cell side inside the pore existing in the partition wall.

Moreover, according to the present invention, there is provided an exhaust gas purifying system comprising: an exhaust gas channel extending from an internal combustion engine constituted so as to exhaust an exhaust gas having a content of particulates which is 0.1 (g/kWh) or less; and any one of the catalyst-carried filters described above in the exhaust gas channel.

Furthermore, according to the present invention, there is provided a catalyst body comprising: a honeycomb structure including a plurality of cells which are partitioned by partition walls constituted of a porous ceramic including a large number of pores to constitute a channel of a gas; and an oxidation catalyst which is carried on the surfaces of the partition walls and inner walls of the pores existing in the partition walls to promote oxidation of particulates contained in an exhaust gas, wherein the plurality of cells include fine coating layer forming cells in which at least one fine coating layer constituted of a porous ceramic having an average pore diameter smaller than that of the porous ceramic constituting the partition wall is formed on the surface of the partition wall, and fine coating layer non-forming cells in which the fine coating layer is not formed on the surface of the partition wall.

According to the present invention, there is also provided a catalyst body comprising: a honeycomb structure including a plurality of cells which are partitioned by partition walls constituted of a porous ceramic including a large number of pores to constitute a channel of a gas; and an oxidation catalyst which is carried on the surfaces of the partition walls and inner walls of the pores existing in the partition walls to promote oxidation of particulates contained in an exhaust gas, wherein the plurality of cells include particulate layer forming cells in which at least one particulate layer filled with a porous ceramic having an average pore diameter smaller than that of the porous ceramic constituting the partition wall is formed on the surface of the partition wall inside the pores existing in the partition wall, and particulate layer non-forming cells in which the particulate layer is not formed on the surface of the partition wall.

Still furthermore, according to the present invention, there is provided a catalyst body comprising: a honeycomb structure including a plurality of cells which are constituted of a porous ceramic including a large number of pores and which are partitioned by partition walls to constitute a channel of a gas; and an oxidation catalyst for promoting oxidation of particulates contained in an exhaust gas, the oxidation catalyst being carried on the surfaces of the partition walls constituting the plurality of cells and inner walls of the pores existing in the partition walls, wherein the plurality of cells include coarse coating layer forming cells in which at least one coarse coating layer constituted of a porous ceramic having an average pore diameter larger than that of the porous ceramic constituting the partition wall is formed on the surface of the partition wall, and coarse coating layer non-forming cells in which the coarse coating layer is not formed on the surface of the partition wall.

### BRIEF DESCRIPTION OF THE DRAWINGS

FIG. 1 is a schematic diagram showing a structure of a general honeycomb structure;

FIG. 2 is a schematic diagram showing an example of a structure in which the honeycomb structure is clogged;

FIG. 3 is an explanatory view showing one embodiment of a conventional catalyst-carried filter and an enlarged sectional view of a portion in the vicinity of a partition wall;

FIGS. 4(a) and 4(b) are explanatory views showing one embodiment of a catalyst-carried filter of the present invention, FIG. 4(a) is an enlarged sectional view of the portion in the vicinity of the partition wall, and FIG. 4(b) is a schematic diagram showing a function of the catalyst-carried filter of the present invention;

FIG. 5 is an explanatory view showing another embodiment of the catalyst-carried filter of the present invention, and a schematic diagram showing the function of the catalyst-carried filter of the present invention; and

FIGS. 6(a) and 6(b) are explanatory views showing still another embodiment of the catalyst-carried filter of the present invention, FIG. 6(a) is an enlarged sectional view of the portion in the vicinity of the partition wall, and FIG. 6(b) is a schematic diagram showing the function of the catalyst-carried filter of the present invention.

### DESCRIPTION OF THE PREFERRED EMBODIMENT

In the following sections, preferred embodiments of the present invention will be described in more detail. However, the present invention should not be construed to be limited therein; various variations, modifications, and improvements can be made without departing from the spirit and scope of the present invention based on the knowledge of those skilled in the art.

To develop a catalyst-carried filter of the present invention, the present inventor first has studied causes for which most of particulates contained in an exhaust gas are deposited on the surfaces of partition walls of the catalyst-carried filter on an exhaust gas inflow cell side in the conventional catalyst-carried filter and do not enter pores existing in the partition walls. As a result, when the exhaust gas containing the particulates flows into an exhaust gas inflow cell of the filter, a large number of particulates contained in the exhaust gas crosslink one another in openings of the pores on the exhaust gas inflow cell side of the partition wall to close the openings of the pores in a comparatively early stage. This phenomenon has been considered to be the cause.

That is, by the phenomenon in which a large number of particulates contained in the exhaust gas crosslink one another in the openings of the pores on the exhaust gas inflow cell side of the partition wall to close the openings of the pores in the comparatively early stage of the exhaust gas inflow, the particulates contained in the subsequently inflowing exhaust gas are not capable of entering the pores existing in the partition wall. Therefore, an oxidation catalyst carried on the inner surfaces of the pores existing in the partition wall cannot contact the particulates, and the oxidation (combustion) of the particulates cannot sufficiently be promoted. Moreover, the particulates in the exhaust gas cannot be reduced. Accordingly, the particulates are deposited on the surface of the partition wall on the exhaust gas inflow cell side in a comparatively short period, and a reproducing operation of the filter (operation of removing the deposited particulates by reverse washing or heating) has to be frequently carried out.

As a result of intensive researches of the above-described phenomenon, the present inventor has found that reduction of an inflow speed of the exhaust gas into the pores existing in the partition wall is effective in order to avoid the above-described phenomenon.

Therefore, in the catalyst-carried filter of the present invention, for example, at least one fine coating layer constituted of a porous ceramic having an average pore diameter smaller than that of the porous ceramic constituting the partition wall is formed on the surfaces of the partition walls defining a plurality of cells on a purified gas outflow cell side. With this catalyst-carried filter, when an airflow resistance is imparted on the purified gas outflow cell side of the partition wall, the inflow speed of the exhaust gas into the pores existing in the partition wall can be lowered. Moreover, it is possible to effectively inhibit the phenomenon in which a large number of particulates contained in the exhaust gas crosslink one another in the openings of the pores in the partition wall on the exhaust gas inflow cell side to close the openings of the pores.

When the above-described filter is used, the openings of the pores are prevented from being closed. Accordingly, the exhaust gas comparatively easily enters the pores existing in the partition wall, a contact degree of the particulates with an oxidation catalyst carried inside the pores existing in the partition wall is enhanced, and it is therefore possible to sufficiently promote the oxidation (combustion) of the particulates. In consequence, the particulates in the exhaust gas can be reduced, a time required for a predetermined amount of particulates to deposit in the exhaust gas inflow cell of the filter lengthens, and it is therefore possible to lower the frequency at which the reproducing operation of the filter is carried out.

Moreover, since the contact degree of the particulates with the oxidation catalyst is enhanced, the oxidation (combustion) of the particulates gradually (stably) proceeds at a comparatively low temperature, a large amount of deposited particulates are therefore burnt at a blast, and an abnormal temperature rise of the filter is inhibited from occurring. Accordingly, it is possible to effectively prevent degradation of the oxidation catalyst and dissolved loss of the filter.

An embodiment of the catalyst-carried filter of the present invention will hereinafter concretely be described. It is to be noted that “average pore diameter” and “porosity” mentioned in the present specification mean the average pore diameter and the porosity measured by a mercury press-in method.

(1) Basic Constitution of Catalyst-Carried Filter

First, a basic constitution of the catalyst-carried filter according to the present invention will be described. The catalyst-carried filter according to the present invention includes: a honeycomb structure including a plurality of cells which are partitioned by partition walls constituted of a porous ceramic including a large number of pores to constitute a channel of a gas; and an oxidation catalyst which is carried on the surfaces of the partition walls and inner walls of the pores existing in the partition walls to promote oxidation of particulates contained in an exhaust gas. One opening end and the other opening end of the plurality of cells are alternately clogged in the catalyst-carried filter.

(I) Honeycomb Structure

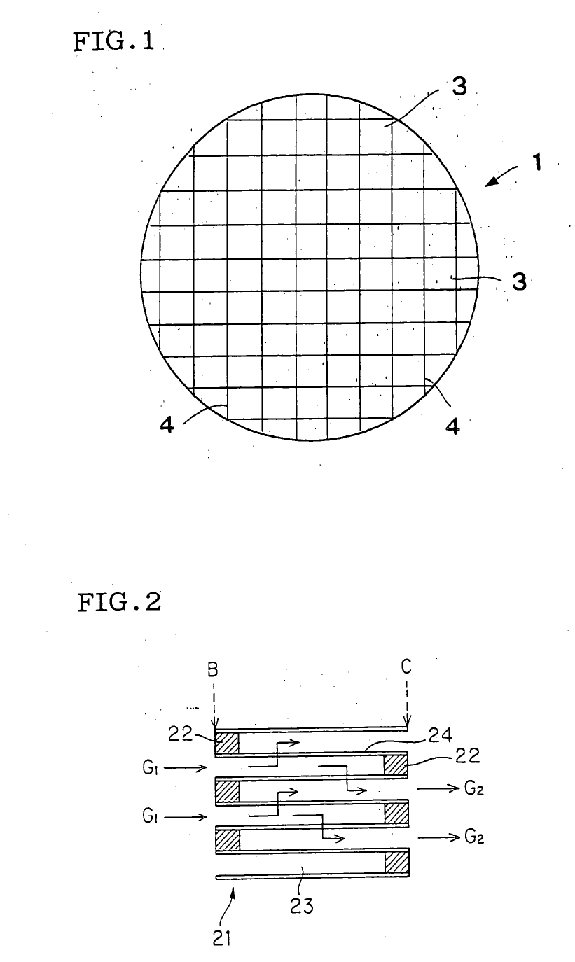

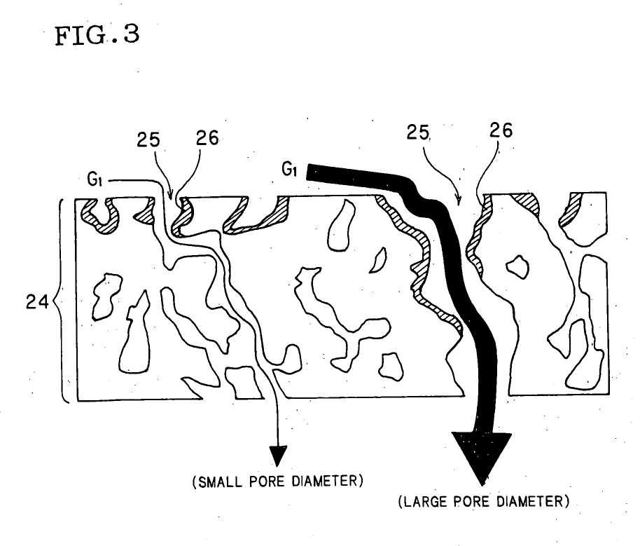

For example, as in a honeycomb structure 1 shown in FIG. 1, the honeycomb structure includes a plurality of cells 3 which are partitioned by partition walls 4 constituted of a porous ceramic including a large number of pores to constitute a channel of a gas. The whole shape of the honeycomb structure is not especially limited, and examples of the shape include a cylindrical shape shown in FIG. 1, a square pole shape, a triangle pole shape, and the like.

Moreover, a cell shape (cell shape in a section vertical to a cell forming direction) of the honeycomb structure is not especially limited, and the examples include a quadrangular cell shown in FIG. 1, a hexagonal cell, a triangular cell, and the like. With a circular cell or a quadrangular or polygonal cell, the catalyst of a corner portion in the cell section is prevented from thickening, and the thickness of a catalyst layer can be uniform. The hexagonal cell is preferable in consideration of a cell density, numerical aperture, and the like.

The cell density of the honeycomb structure is not. especially limited, but when the body is used as the catalyst-carried filter as in the present invention, the cell density is preferably in a range of 6 to 1500 cells/square inch: (0.9 to 233 cells/cm²). The thickness of the partition wall is preferably in a range of 20 to 2000 μm.

Furthermore, when the body is used as the catalyst-carried filter as in the present invention, one and the other opening ends of a plurality of cells are alternately clogged in the structure. For example, as shown in FIG. 2, a honeycomb structure 21 including a plurality of cells 23 partitioned by partition walls 24 constituted of a porous ceramic including a large number of pores to constitute the channel of the gas is structured in such a manner that one and the other opening ends of the plurality of cells 23 are alternately clogged by clogging portions 22. In this honeycomb structure 21, when an exhaust gas G₁ flows into the body via an exhaust gas inflow cell opening toward an end surface B on an exhaust gas inflow side, the particulates in the exhaust gas G₁ are trapped/collected by the partition walls during passage of the exhaust gas G₁ through the partition walls 24. A purified gas G₂ from which the particulates have been removed flows out of a purified gas outflow cell opening toward an end surface C on an exhaust gas outflow side.

The material of the honeycomb structure is not especially limited, but a ceramic can preferably be used, and any of cordierite, silicon carbide, alumina, mullite, and silicon nitride is preferable from viewpoints of a strength, heat resistance, corrosion resistance, and the like.

For the above-described honeycomb structure, for example, in addition to aggregate particles formed of a ceramic and water, an organic binder (hydroxylpropoxyl methyl cellulose, methyl cellulose, and the like), a hole making material (graphite, starch, synthetic resin, the like), and a surface active agent (ethylene glycol, fatty acid soap, and the like) are mixed and kneaded to form a puddle. The puddle is molded in a desired shape and dried to obtain a molded material, and the molded material can be calcined to obtain the honeycomb structure.

It is to be noted that as a molding method, a method of using a cap having a desired cell shape, partition wall thickness, and cell density to extrude/mold the puddle prepared as described above can preferably be used. The examples of a method of alternately clogging the exhaust gas inflow side end surfaces and purified gas outflow side end surfaces of the plurality of cells by the clogging portions include a method of drying a honeycomb molded material and subsequently charging the puddle having the same composition as that for the molding into the cell openings.

(II) Oxidation Catalyst

The oxidation catalyst is a catalyst for promoting the oxidation of the particulates contained in the exhaust gas, and noble metals such as platinum (Pt), palladium (Pd), and rhodium (Rh) are preferably used.

It is to be noted that at least the oxidation catalyst needs to be carried in the catalyst-carried filter of the present invention, but another catalyst or purifying material may also be carried. For example, an NOₓ occlusion catalyst formed of an alkali metal (Li, Na, K, Cs, etc.) or an alkali earth metal (Ca, Ba, Sr, etc.), a three-way catalyst, a co-catalyst represented by oxide of cerium (Ce) and/or zirconium (Zr), a hydrocarbon (HC) adsorbing material, and the like may also be carried.

A method of carrying catalyst components of the oxidation catalyst, NOₓ occlusion catalyst, and the like is not especially limited, and the examples thereof include a method of wash-coating the partition walls of the honeycomb structure with a catalyst solution containing the catalyst components and subsequently thermally treating and burning the walls. Since the catalyst components of the oxidation catalyst, NOₓ occlusion catalyst, and the like are carried in a highly scattered state, it is preferable to once carry the components by heat-resistant inorganic oxide having a large specific surface area, such as alumina, before carrying the components by the partition walls of the honeycomb structure.

The oxidation catalyst is carried on the surfaces of the partition walls which define the plurality of cells of the honeycomb structure and the inner walls of the pores existing in the partition walls. Therefore, for the catalyst-carried filter according to the present invention, the plurality of cells in the honeycomb structure is constituted of exhaust gas inflow cells whose one opening end is clogged and in which the oxidation catalyst is carried on the surfaces of the partition walls, and the purified gas outflow cells whose other opening end is clogged, and have a structure inner wall the exhaust gas inflow cells and the purified gas outflow cells are alternately arranged. It is to be noted that in this structure, the oxidation catalyst may also be carried on the surfaces of the partition walls of the purified gas outflow cells. That is, the catalyst-carried filter according to the present invention also includes a filter inner wall the oxidation catalyst is carried both by the surfaces of the partition walls of the exhaust gas inflow cell and the purified gas outflow cell.

(2) First Embodiment of Catalyst-Carried Filter of the Invention

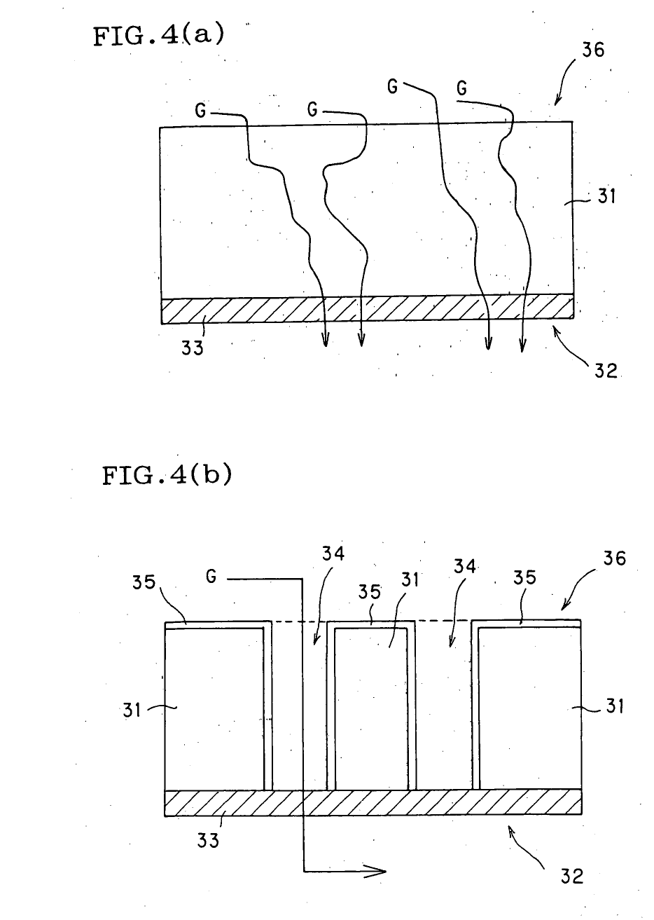

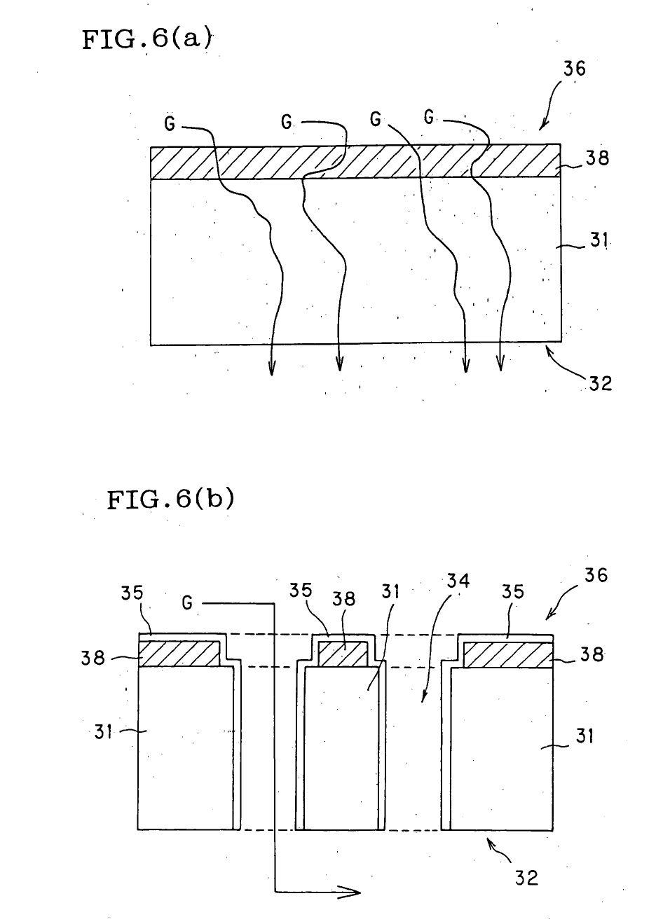

In a first embodiment of the catalyst-carried filter of the present invention, for example, as shown in FIGS. 4(a) and 4(b), at least one fine coating layer 33 constituted of a porous ceramic having an average pore diameter smaller than that of the porous ceramic constituting a partition wall 31 is formed on a surface 32 of the partition wall 31 defining the plurality of cells of the honeycomb structure on the purified gas outflow cell side. It is to be noted that in FIGS. 4(a), 4(b), 5, 6(a), 6(b), reference numeral 36 denotes the surface on the exhaust gas inflow cell side. In FIGS. 4(a), 6(a), the pores and the oxidation catalyst are omitted.

In accordance with the above-described filter, since the airflow resistance is imparted by the fine coating layer 33 formed on the surface 32 of the partition wall 31 on the purified gas, outflow cell side, the inflow speed of an exhaust gas G into pores 34 existing in the partition wall 31 can be lowered. It is possible to effectively inhibit a phenomenon in which a large number of particulates contained in the exhaust gas G crosslink one another in the openings of the pores in the partition wall 31 on the exhaust gas inflow cell side to close the openings of the pores 34.

Moreover, even if the average pore diameter of the partition wall 31 is not constituted to be large in the above-described filter, the contact degree of an oxidation catalyst 35 carried on the inner walls of the pores 34 existing in the partition wall 31 with the particulates contained in the exhaust gas G is enhanced. Therefore, the oxidation (combustion) of the particulates can sufficiently be promoted without lowering a strength of the partition wall 31 (and the honeycomb structure).

Furthermore, since the fine coating layer 33 is formed on the surface 32 of the partition wall 31 on the purified gas outflow cell side in the above-described filter, the particulates can securely be trapped/collected. Especially, even when defects (pores having a large pore diameter) exist in a part of the partition wall 31, the exhaust gas G can be prevented from flowing into the defects in a concentrated manner. Moreover, it is possible to prevent a situation in which the particulates leak toward the purified gas outflow cell from the defect.

In the first embodiment, the porous ceramic constituting the partition wall has an average pore diameter of preferably 15 to 300 μm, more preferably 20 to 70 μm. When the average pore diameter of the porous ceramic constituting the partition wall is less than the range, there is a problem that the particulates contained in the exhaust gas do not easily enter the pores of the partition wall. When the diameter exceeds the range, there is unfavorably a problem that it is difficult to form the fine coating layer on the surface of the partition wall. On the other hand, the average pore diameter of the porous ceramic constituting the fine coating layer is preferably 5 to 50 μm, further preferably 15 to 40 μm. When the average pore diameter of the porous ceramic constituting the fine coating layer is less than the range, there is a problem that a pressure loss increases. When the diameter exceeds the range, there is unfavorably a problem that the particulates easily leak toward the purified gas outflow cell side.

In the first embodiment, the porous ceramic constituting the partition wall has a porosity of preferably 40 to 75%, further preferably 60 to 70%. When the porosity of the porous ceramic constituting the partition wall is less than the range, an amount of deposited particulates is large with respect to a volume inside the pore of the partition wall. Therefore, there is a problem that it is difficult to perform the reproducing operation of the filter. When the porosity exceeds the range, the strength of the honeycomb structure constituting the catalyst-carried filter drops, and it is unfavorably difficult to perform canning. On the other hand, the porosity of the porous ceramic constituting the fine coating layer is preferably 45 to 80%. When the porosity of the porous ceramic constituting the fine coating layer is less than 45%, there is a problem that the pressure loss increases. When the porosity exceeds 80%, the strength of the fine coating layer becomes insufficient, and hence, there is unfavorably a problem that the fine coating layer peels from the surface of the partition wall.

It is to be noted that the porosity of the porous ceramic constituting the fine coating layer is preferably greater than that of the porous ceramic constituting the partition wall by 5% or more. When a difference between both the porosities is set to 5% or more, there is an advantage that the pressure loss (transmission pressure loss) in the fine coating layer can be reduced.

For the fine coating layer, a ceramic film forming method which has heretofore been known, such as a dipping method, is used to attach a ceramic slurry to the surface of the partition wall of the honeycomb structure on the purified gas outflow cell side and to dry and calcine the, slurry, so that a thin-film fine coating layer may be formed. In this case, the average pore diameter of the fine coating layer may be adjusted to a desired value, when a particle size, blend ratio, or the like of aggregate particles in the ceramic slurry is controlled. The porosity may be adjusted to the desired value, when the particle size of the aggregate particles in the ceramic slurry, the amount of hole making materials, and the like are controlled. The coating layer thickness may be adjusted to the desired value, when a concentration of the ceramic slurry or a time required for forming the film is controlled. It is to be noted that two or more fine coating layers may also be formed as indicated by “at least one fine coating layer”.

(3) Second Embodiment of Catalyst-Carried Filter of the Invention

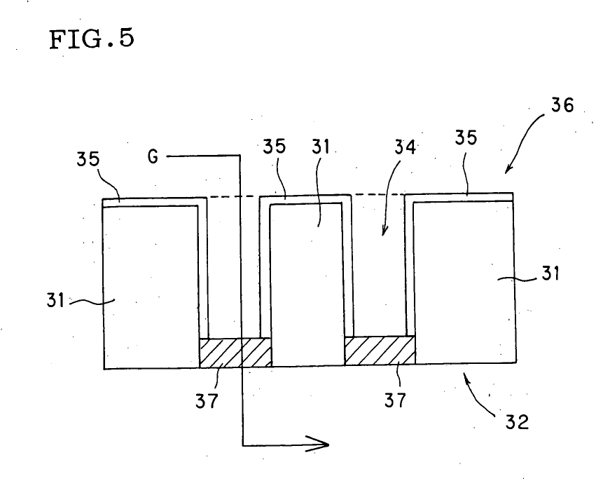

In a second embodiment of the catalyst-carried filter of the present invention, for example, as shown in FIG. 5, at least one particulate layer 37 filled with the porous ceramic having an average pore diameter smaller than that of the porous ceramic constituting the partition wall 31 is formed on the purified gas outflow cell inside the pores 34 existing in the partition wall 31 which defines the plurality of cells of the honeycomb structure.

In accordance with the above-described filter, since the airflow resistance is imparted by the particulate layer 37 formed on the purified gas outflow cell side in the pores 34 existing in the partition wall 31, an effect similar to that of the catalyst-carried filter of the first embodiment can be obtained.

Moreover, in the above-described filter, different from the first embodiment, the particulate layer 37 exists only inside the pores 34, and any coating layer does not exist on the surface of the partition wall 31. Therefore, there is an advantage that the pressure loss can be reduced without decreasing an inner volume of the cell.

In the second embodiment, the porous ceramic constituting the partition wall has an average pore diameter of preferably 15 to 300 μm, more preferably 20 to 70 μm. When the average pore diameter of the porous ceramic constituting the partition wall is less than the range, there is a problem that the particulates contained in the exhaust gas do not easily enter the pores of the partition wall. When the diameter exceeds the range, there is unfavorably a problem that it is difficult to form the particulate layer on the surface of the partition wall.

On the other hand, the average pore diameter of the porous ceramic constituting the particulate layer is preferably 5 to 50 μm, further preferably 15 to 40 μm. When the average pore diameter of the porous ceramic constituting the particulate layer is less than the range, there is a problem that the pressure loss increases. When the diameter exceeds the range, there is unfavorably a problem that the particulates easily leak toward the purified gas outflow cell side.

In the second embodiment, the porous ceramic constituting the partition wall has a porosity of preferably 40 to 75%, further preferably 60 to 70%. When the porosity of the porous ceramic constituting the partition wall is less than the range, the amount of deposited particulates is large with respect to the volume inside the pore of the partition wall. Therefore there is a problem that it is difficult to perform the reproducing operation of the filter. When the porosity exceeds the range, the strength of the honeycomb structure constituting the catalyst-carried filter drops, and it is unfavorably difficult to perform the canning.

On the other hand, the porosity of the porous ceramic constituting the particulate layer is preferably 45 to 80%. When the porosity of the porous ceramic constituting the particulate layer is less than 45%, there is a problem that the pressure loss increases. When the porosity exceeds 80%, the strength of the particulate layer becomes insufficient, and hence there is unfavorably a problem that the particulate layer drops off the surface of the partition wall. It is to be noted that the porosity of the porous ceramic constituting the particulate layer is preferably greater than that of the porous ceramic constituting the partition wall by 5% or more. When the difference between both the porosities is set to 5% or more, there is an advantage that the pressure loss (transmission pressure loss) in the particulate layer can be reduced.

For the particulate layer, for example, a capillary phenomenon is used to allow the ceramic slurry to permeate the pores existing in the partition wall of the honeycomb structure on the purified gas outflow cell side, ceramic particles are charged into the pores, and the ceramic slurry remaining on the surface of the partition wall on the purified gas outflow cell side is blown/flied by methods such as air blowing. Subsequently, the particulate layer can be formed by methods such as the drying and calcining. In this case, the average pore diameter of the particulate layer may be adjusted to the desired value, when the particle size, blend ratio, or the like of aggregate particles in the ceramic slurry is controlled. The porosity may be adjusted to the desired value, when the particle size of the aggregate particles in the ceramic slurry, the amount of hole making materials, and the like are controlled. The coating layer thickness may be adjusted to the desired value, when the concentration of the ceramic slurry or the time required for forming the film is controlled. It is to be noted that two or more particulate layers may also be formed as indicated by “at least one particulate layer”.

(4) Third Embodiment of Catalyst-Carried Filter of the Invention

In a third embodiment of the catalyst-carried filter of the present invention, for example, as shown in FIGS. 6(a) and 6(b), at least one coarse coating layer 38 constituted of the porous ceramic having an average pore diameter larger than that of the porous ceramic constituting the partition wall 31 is formed on a surface 36 of the partition wall 31 which defines the plurality of cells of the honeycomb structure on the exhaust gas inflow cell side. Moreover, the oxidation catalyst 35 is carried on the surface of the coarse coating layer 38 and the inner walls of the pores existing in the coarse coating layer 38.

In accordance with the above-described filter, the surface 36 of the partition wall 31 on the exhaust gas inflow cell side is formed to be coarse by the coarse coating layer 38 formed on the surface 36 of the partition wall 31 on the exhaust gas inflow cell side. Therefore, the average pore diameter on a partition wall 31 surface side can be increased, and it is possible to reduce the phenomenon in which a large number of particulates contained in the exhaust gas G crosslink one another in the openings of the pores in the partition wall 31 on the exhaust gas inflow cell side to close the openings of the pores 34.

Moreover, in the above-described filter, a catalyst carrying area increases by the surface of the coarse coating layer 38 and the inner walls of the pores existing in the coarse coating layer 38 without enlarging the average pore diameter of the partition wall 31. Accordingly, the oxidation (combustion) of the particulates can sufficiently be promoted without lowering the strength of the partition wall 31 (and the honeycomb structure)

In the third embodiment, the porous ceramic constituting the partition wall has an average pore diameter of preferably 5 to 50 μm, more preferably 15 to 40 μm. When the average pore diameter of the porous ceramic constituting the partition wall is less than the range, there is a problem that the pressure loss increases. When the diameter exceeds the range, there is unfavorably a problem that the particulates easily leak on the purified gas outflow cell side. On the other hand, the average pore diameter of the porous ceramic constituting the coarse coating layer is preferably 15 to 300 μm, further preferably 20 to 70 μm.

When the average pore diameter of the porous ceramic constituting the coarse coating layer is less than the range, there is a problem that the particulates contained in the exhaust gas do not easily enter the pores of the partition wall. Conversely, when the coarse coating layer having the average pore diameter exceeding the range is formed, the average pore diameter of the aggregate particles for use in forming the coarse coating layer has to be increased. Therefore, the coarse coating layer thickens, and a sectional area of the cell opening decreases. Accordingly, the pressure loss (transmission. pressure loss) in the coarse coating layer increases. Additionally, there is a problem that the pressure loss (transmission pressure loss) during movement of the exhaust gas in the cell increases.

In the third embodiment, the porous ceramic constituting the partition wall has a porosity of preferably 45 to 80%. When the porosity of the porous ceramic constituting the partition wall is less than 45%, there is a problem that the pressure loss increases. When the porosity exceeds 80%, the strength of the honeycomb structure constituting the catalyst-carried filter drops, and there is unfavorably a problem that the canning is difficult. On the other hand, the porosity of the porous ceramic constituting the coarse coating layer is preferably 40 to 75%, further preferably 60 to 70%.

When the porosity of the porous ceramic constituting the coarse coating layer is less than the range, the amount of deposited particulates is large with respect to the volume inside the pore of the partition wall, and there is a problem that the reproducing operation of the filter becomes difficult. When the porosity exceeds the range, the strength of the coarse coating layer becomes insufficient, and therefore there is unfavorably a problem that the coarse coating layer peels from the surface of the partition wall. It is to be noted that the porosity of the porous ceramic constituting the partition wall is preferably greater than that of the porous ceramic constituting the coarse coating layer by 5% or more. When the difference between both the porosities is set to 5% or more, there is an advantage that the pressure loss (transmission pressure loss) in the porous ceramic constituting the partition wall can be reduced.

For the coarse coating layer, in the same manner as in the first embodiment, the ceramic film forming method which has heretofore been known, such as the dipping method, is used to attach the ceramic slurry to the surface of the partition wall of the honeycomb structure on the exhaust gas inflow cell side and to dry and calcine the slurry, so that a thin-film fine coarse coating layer may be formed. In this case, the average pore diameter of the coarse coating layer may be adjusted to the desired value, when the particle size, blend ratio, or the like of aggregate particles in the ceramic slurry is controlled. The porosity may be adjusted to the desired value, when the particle size of the aggregate particles in the ceramic slurry, the amount of hole making materials, and the like are controlled. The thickness of the coating layer may be adjusted to the desired value, when the concentration of the ceramic slurry or the time required for forming the film is controlled. It is to be noted that two or more coarse coating layers may also be formed as indicated by “at least one coarse coating layer”.

Furthermore, when the third embodiment is combined with the first or second embodiment, the effect of both the embodiments can advantageously be produced. For example, the coarse coating layer is formed on the surface of the, partition wall of the honeycomb structure on the exhaust gas inflow cell side to carry the oxidation catalyst at least on the surface of the coarse coating layer and the inner walls of the pores existing in the coarse coating layer. Moreover, it is preferable to form the fine coating layer on the surface of the partition wall on the purified gas outflow cell side or to form the particulate layer on the purified gas outflow cell side inside the pores existing in the partition wall.

(5) Exhaust Gas Purifying System

In recent years, with strengthening of exhaust gas regulations, an engine (internal combustion engine) having a small discharge amount of particulates has been developed in an automobile industry. When the above-described catalyst-carried filter of the present invention is combined with this low particulate discharge type engine, it is possible to construct an effective exhaust gas purifying system.

Concretely, the catalyst-carried filter of the present invention is disposed in an exhaust gas channel from the internal combustion engine constituted to exhaust the exhaust gas having a content of particulates which is 0.1 g/kWh or less (more preferably 0.01 to 0.1 g/kWh). In this exhaust gas purifying system, it is possible to set a speed for oxidizing (burning) the particulates to reproduce the filter to be higher than that for depositing the particulates on the surface of the partition wall of the honeycomb structure constituting the catalyst-carried filter and inside the pores existing in the partition wall. There is an advantage that the filter can Continuously be reproduced.

(6) Catalyst Body

The catalyst-carried filter of the present invention has been described above, and a catalyst body having a constitution similar to that described above also produces a preferable effect as compared with a conventional catalyst body.

The catalyst body of the present invention is constituted in the same manner as in the catalyst-carried filter (first to third embodiments) of the present invention except that the opening ends of the plurality of cells of the honeycomb structure are not clogged. Concretely, (i) at least one fine coating layer described above is formed on the surface of the partition wall in some of the cells of the honeycomb structure; (ii) at least one particulate layer described above is formed on the surface of the partition wall inside the pore existing in the partition wall in some of the cells of the honeycomb structure; and (iii) at least one coarse coating layer described above is formed on the surface of the partition wall in some of the cells of the honeycomb structure.

With adopting the catalyst body mentioned above, the opening of the pore is prevented from being closed. Therefore, as compared with the conventional catalyst body, the exhaust gas comparatively easily enters the pores existing in the partition wall, and the contact degree of the particulates with the oxidation catalyst carried inside the pores existing in the partition wall is enhanced. Accordingly, the oxidation (combustion) of the particulates can sufficiently be promoted. Moreover, since the particulates with a size of 300 nm or less contained in the exhaust gas easily enter the pores of the partition wall by diffusion movement, the catalyst body is preferably usable in that an effect of promoting the oxidation (combustion) of the particulates is large.

It is to be noted that for the catalyst body of the present invention, in the same manner as in the catalyst-carried filter of the present invention, the fine coating layer forming cell and fine coating layer non-forming cell, the particulate layer forming cell and particulate layer non-forming cell, or the coarse coating layer forming cell and coarse coating layer non-forming cell are preferably alternately arranged.

Moreover, the catalyst body of the present invention may be constituted in conformity to the catalyst-carried filter of the present invention with respect to the average pore diameter and the porosity of the porous ceramic constituting the partition wall, fine coating layer, particulate layer, or coarse coating layer. The method of forming the fine coating layer, particulate layer, or coarse coating layer is also similar to that of the catalyst-carried filter of the present invention.

(7) Application

The catalyst-carried filter, exhaust gas purifying system, and catalyst body of the present invention described above can preferably be used to trap/collect or purify the particulates contained in the exhaust gas exhausted from internal combustion engines such as a diesel engine, an engine for an ordinary automobile, and an engine for large-scaled automobiles such as a track and a bus, and various combustion devices.

### EXAMPLE

The present invention will hereinafter be described in more detail in accordance with examples, but is not limited to these examples. It is to be noted that in the following example and comparative example, as the “average particle diameter”, a value of 50% particle diameter was used. The value was measured by an X-ray transmission type particle size distribution measurement device (e.g., Sedigraph 5000-02 model manufactured by Shimazu Corp.) using Stokes' liquid phase sedimentation method as a measurement principle to detect the diameter by an X-ray transmission method.

[Honeycomb Structure]

The following honeycomb structure was used both in the example and comparative example to constitute the, catalyst-carried filter.

This honeycomb structure was formed of cordierite, an end surface (cell opening surface) shape was circular with an outer diameter of 194 mmφ, the length was 152 mm, the cell shape was square having a size of 1.17 mm×1.17 mm, the thickness of the partition wall was 12 mil (300 μm), and the cell density was 46.5 cells/cm² (300 cells/square inch). The porosity of the honeycomb structure measured by the mercury press-in method was 65%, and the average pore diameter was 25 μm. This honeycomb structure has a structure in which one opening end and the other opening end of the plurality of cells are alternately clogged;

### Comparative Example 1

By using a method in which the surface of the partition wall of the honeycomb structure on the exhaust gas inflow cell side was wash-coated with a catalyst solution containing Pt as the oxidation catalyst and thereafter the solution was thermally treated and fired at a high temperature, the catalyst-carried filter of Comparative Example 1 was obtained. In the catalyst-carried filter of Comparative Example 1, Pt was carried at a ratio of 1 g/L.

### Example 1

The thin-film fine coating layer was formed by using a method in which the ceramic slurry containing a cordierite powder having an average particle diameter of 12 μm was attached to the surface of the partition wall of the honeycomb structure on the purified gas outflow cell side, dried, and fired. The porosity of the fine coating layer measured by the mercury press-in method was 55%, the average pore diameter was 15 um, and the coating layer thickness was 30 μm.

As described above, the catalyst-carried filter of Example 1 was obtained by the method of wash-coating the surface of the partition wall of the honeycomb structure on which the fine coating layer was formed as described above on the exhaust gas inflow cell side with the catalyst solution containing Pt which was the oxidation catalyst, and subsequently thermally treating arid firing the surface at a high temperature. In the catalyst-carried filter of Example 1, Pt was carried at a ratio of 1 g/L.

[Evaluation Method]

With respect to the catalyst-carried filters of Comparative Example 1 and Example 1 described above, a diesel engine having a displacement volume of 2.5 L was used, and the particulates (soot) were deposited (attached) onto the catalyst-carried filter, while a pressure loss value was measured. In this case, an inflow temperature of the exhaust gas was 300° C., the exhaust gas flow rate was 2.5 Nm³/min, and the diameter of the particulate was about 20 to 400 nm.

For the catalyst-carried filters of Comparative Example 1 and Example 1, the pressure loss values were compared with each other at the time when an amount of generated particulates reached 10 g. Then, the pressure loss value of the catalyst-carried filter of Comparative Example 1 was 15 kPa, and that of the catalyst-carried filter of Example 1 was 8 kPa which was a low value. After the measurement of the pressure loss value, trapping/collecting efficiencies of particulates of the catalyst-carried filters of Comparative Example 1 and Example 1 (ratio of particulates removed by the trapping/collecting into the filter or the burning in the filter) were measured. Then, the trapping/collecting efficiency of the catalyst-carried filter of Comparative Example 1 was 92%, and that of the catalyst-carried filter of Example 1 was 97% which was high.

As described above, it was confirmed that the catalyst-carried filter of Example 1 was larger in the amount of trapped/collected particulates, but lower in the pressure loss value at the time of the attachment of particulates than the catalyst-carried filter of Comparative Example 1. That is, it has been recognized that the trapped/collected particulates can sufficiently be brought into contact with the oxidation catalyst in the catalyst-carried filter of Example 1, therefore the particulates in the exhaust gas can be decreased, and the frequency of the reproducing operation of the filter can be lowered.

As described above, for the catalyst-carried filter of the present invention, at least one fine coating layer constituted of a porous ceramic having an average pore diameter smaller than that of the porous ceramic constituting the partition wall is formed on the surface of a partition wall defining a plurality of cells of a honeycomb structure on a purified gas outflow cell side. Therefore, needless to say, particulates contained in an exhaust gas can securely be trapped/collected. Moreover, the oxidation catalyst carried in the pores existing in the partition wall can sufficiently be brought into contact with the particulates. Accordingly, the particulates in the exhaust gas can be reduced, and the frequency of the reproducing operation of the filter can be lowered.

Moreover, since a contact degree of the particulates with the oxidation catalyst is enhanced, the oxidation (combustion) of the particulates gradually (stably) proceeds at a comparatively low temperature. In consequence, a large amount of deposited particulates are burned at a blast, and any abnormal temperature rise of the filter is not caused. Therefore, it is possible to effectively prevent degradation of the oxidation catalyst or the dissolved loss of the filter.

What is claimed is:

1. A catalyst-carried filter comprising:
a honeycomb structure including a plurality of cells which are partitioned by partition walls constituted of a porous ceramic including a large number of pores to constitute a channel of a gas; and
an oxidation catalyst which is carried on the surfaces of the partition walls and inner walls of the pores existing in the partition walls to promote oxidation of particulates contained in an exhaust gas, the plurality of cells including one opening end and the other opening end which are alternately clogged,
wherein the plurality of cells include exhaust gas inflow cells whose one opening end is clogged and in which the oxidation catalyst is carried on the surfaces of the partition walls, and purified gas outflow cells whose other opening end is clogged, the exhaust gas inflow cells and the purified gas outflow cells are alternately arranged, and at least one fine coating layer constituted of a porous ceramic having an average pore diameter smaller than that of the porous ceramic constituting the partition wall is formed on the surface of the partition wall on the side of the purified gas outflow cell.

2. The catalyst-carried filter according to claim 1, wherein the average pore diameter of the porous ceramic constituting the partition wall is 15 to 300 μm, and the average pore diameter of the porous ceramic constituting the fine coating layer is 5 to 50 μm.

3. The catalyst-carried filter according to claim 2, wherein the porous ceramic constituting the partition wall has a porosity of 40 to 75%, and the porous ceramic constituting the fine coating layer has a porosity of 45 to 85%.

4. The catalyst-carried filter according to claim 3, wherein the porosity of the porous ceramic constituting the partition wall is smaller than that of the porous ceramic constituting the fine coating layer by 5% or more.

5. A catalyst-carried filter comprising:
a honeycomb structure including a plurality of cells which are partitioned by partition walls constituted of a porous ceramic including a large number of pores to constitute a channel of a gas; and
an oxidation catalyst which is carried on the surfaces of the partition walls and inner walls of the pores existing in the partition walls to promote oxidation of particulates contained in an exhaust gas, the plurality of cells including one opening end and the other opening end which are alternately clogged,
wherein the plurality of cells include exhaust gas inflow cells whose one opening end is clogged and in which the oxidation catalyst is carried on the surfaces of the partition walls, and purified gas outflow cells whose other opening end is clogged, the exhaust gas inflow cells and the purified gas outflow cells are alternately arranged, and at least one particulate layer filled with a porous ceramic having an average pore diameter smaller than that of the porous ceramic constituting the partition wall is formed on an inner portion of the pore existing in the partition wall on the side of the purified gas outflow cell.

6. The catalyst-carried filter according to claim 5, wherein the average pore diameter of the porous ceramic constituting the partition wall is 15 to 300 μm, and the average pore diameter of the porous ceramic constituting the particulate layer is 5 to 50 μm.

7. The catalyst-carried filter according to claim 6, wherein the porous ceramic constituting the partition wall has a porosity of 40 to 75%, and the porous ceramic constituting the particulate layer has a porosity of 45 to 85%.

8. The catalyst-carried filter according to claim 7, wherein the porosity of the porous ceramic constituting the partition wall is smaller than that of the porous ceramic constituting the particulate layer by 5% or more.

9. A catalyst-carried filter comprising:
a honeycomb structure including a plurality of cells which are partitioned by partition walls constituted of a porous ceramic including a large number of pores to constitute a channel of a gas; and
an oxidation catalyst which is carried on the surfaces of the partition walls and inner walls of the pores existing in the partition walls to promote oxidation of particulates contained in an exhaust gas, the plurality of cells including one opening end and the other opening end which are alternately clogged,
wherein the plurality of cells include exhaust gas inflow cells whose one opening end is clogged and in which the oxidation catalyst is carried on the surfaces of the partition walls, and purified gas outflow cells whose other opening end is clogged, the exhaust gas inflow cells and the purified gas outflow cells are alternately arranged, at least one coarse coating layer constituted of a porous ceramic having an average pore diameter larger than that of the porous ceramic constituting the partition wall is formed on the surface of the partition wall on the side of the exhaust gas inflow cell, and the oxidation catalyst is carried on the surface of the coarse coating layer and the inner walls of the pores existing in the coarse coating layer.

10. The catalyst-carried filter according to claim 9, wherein the average pore diameter of the porous ceramic constituting the partition wall is 5 to 50 μm, and the average pore diameter of the porous ceramic constituting the coarse coating layer is 15 to 300 μm.

11. The catalyst-carried filter according to claim 10, wherein the porous ceramic constituting the partition wall has a porosity of 45 to 80%, and the porous ceramic constituting the coarse coating layer has a porosity of 40 to 75%.

12. The catalyst-carried filter according to claim 11, wherein the porosity of the porous ceramic constituting the partition wall is larger than that of the porous ceramic constituting the coarse coating layer by 5% or more.

13. The catalyst-carried filter according to claim 9, further comprising: at least one fine coating layer which is constituted of a porous ceramic having an average pore diameter smaller than that of the porous ceramic constituting the partition wall and which is formed on the surface of the partition wall on the purified gas outflow cell side.

14. The catalyst-carried filter according to claim 9, further comprising: at least one particulate layer which is filled with the porous ceramic having an average pore diameter smaller than that of the porous ceramic constituting the partition wall and which is formed on the purified gas outflow cell side inside the pore existing in the partition wall.

15. An exhaust gas purifying system comprising:
an exhaust gas channel extending from an internal combustion engine constituted so as to exhaust an exhaust gas having a content of particulates which is 0.1 (g/kWh) or less; and
the catalyst-carried filter according to claim 1 in the exhaust gas channel.

16. An exhaust gas purifying system comprising:
an exhaust gas channel extending from an internal combustion engine constituted so as to exhaust an exhaust gas having a content of particulates which is 0.1 (g/kWh) or less; and
the catalyst-carried filter according to claim 5 in the exhaust gas channel.

17. An exhaust gas purifying system comprising:
an exhaust gas channel extending from an internal combustion engine constituted so as to exhaust an exhaust gas having a content of particulates which is 0.1 (g/kWh) or less; and
the catalyst-carried filter according to claim 9 in the exhaust gas channel.

18. A catalyst body comprising:
a honeycomb structure including a plurality of cells which are partitioned by partition walls constituted of a porous ceramic including a large number of pores to constitute a channel of a gas; and
an oxidation catalyst which is carried on the surfaces of the partition walls and inner walls of the pores existing in the partition walls to promote oxidation of particulates contained in an exhaust gas,
wherein the plurality of cells include fine coating layer forming cells in which at least one fine coating layer constituted of a porous ceramic having an average pore diameter smaller than that of the porous ceramic constituting the partition wall is formed on the surface of the partition wall, and fine coating layer non-forming cells in which the fine coating layer is not formed on the surface of the partition wall.

19. A catalyst body comprising:
a honeycomb structure including a plurality of cells which are partitioned by partition walls constituted of a porous ceramic including a large number of pores to constitute a channel of a gas; and
an oxidation catalyst which is carried on the surfaces of the partition walls and inner walls of the pores existing in the partition walls to promote oxidation of particulates contained in an exhaust gas,
wherein the plurality of cells include particulate layer forming cells in which at least one particulate layer filled with a porous ceramic having an average pore diameter smaller than that of the porous ceramic constituting the partition wall is formed on the surface of the partition wall inside the pores existing in the partition wall, and particulate layer non-forming cells in which the particulate layer is not formed on the surface of the partition wall.

20. A catalyst body comprising:
a honeycomb structure including a plurality of cells which are constituted of a porous ceramic including a large number of pores and which are partitioned by partition walls to constitute a channel of a gas; and
an oxidation catalyst for promoting oxidation of particulates contained in an exhaust gas, the oxidation catalyst being carried on the surfaces of the partition walls constituting the plurality of cells and inner walls of the pores existing in the partition walls,
wherein the plurality of cells include coarse coating layer forming cells in which at least one coarse coating layer constituted of a porous ceramic having an average pore diameter larger than that of the porous ceramic constituting the partition wall is formed on the surface of the partition wall, and coarse coating layer non-forming cells in which the coarse coating layer is not formed on the surface of the partition wall.
